(19) United States
(12) Patent Application Publication
(10) Pub. No.: US 2012/0325016 A1
(43) Pub. Date: Dec. 27, 2012

(54) Flow meter for installation between existing electric solenoid water valve and its controller

(76) Inventor: Ori Peled, Las Vegas, NV (US)

(21) Appl. No.: 13/067,707

(22) Filed: Jun. 22, 2011

(51) Int. Cl. G01F 15/14

(52) U.S. Cl. 73/861.77; 73/273

(57) ABSTRACT

A Flow Meter that can be installed on an existing pair of wires that connect an existing electric valve and its controller without the need to lay out additional electrical wiring, which comprises a hollow main body designed to house the internal components of the Flow Meter; one or more pipe clamps used to attach the main body to the existing pipe; an impeller that revolves when water flows through the pipe; an electric circuit; a circuit housing; a sensor; a sensor housing; and a cover.

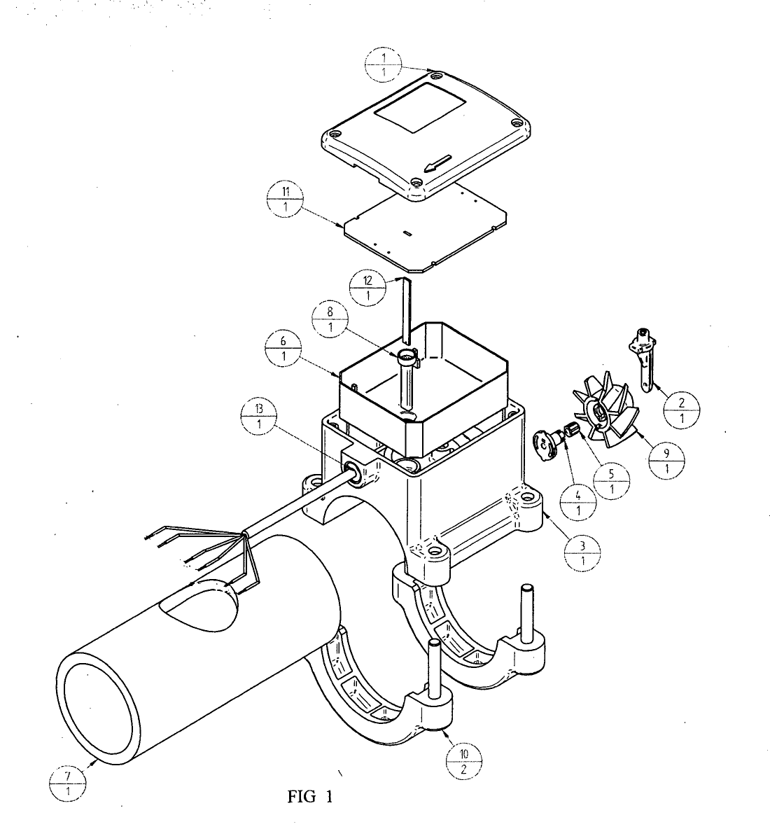

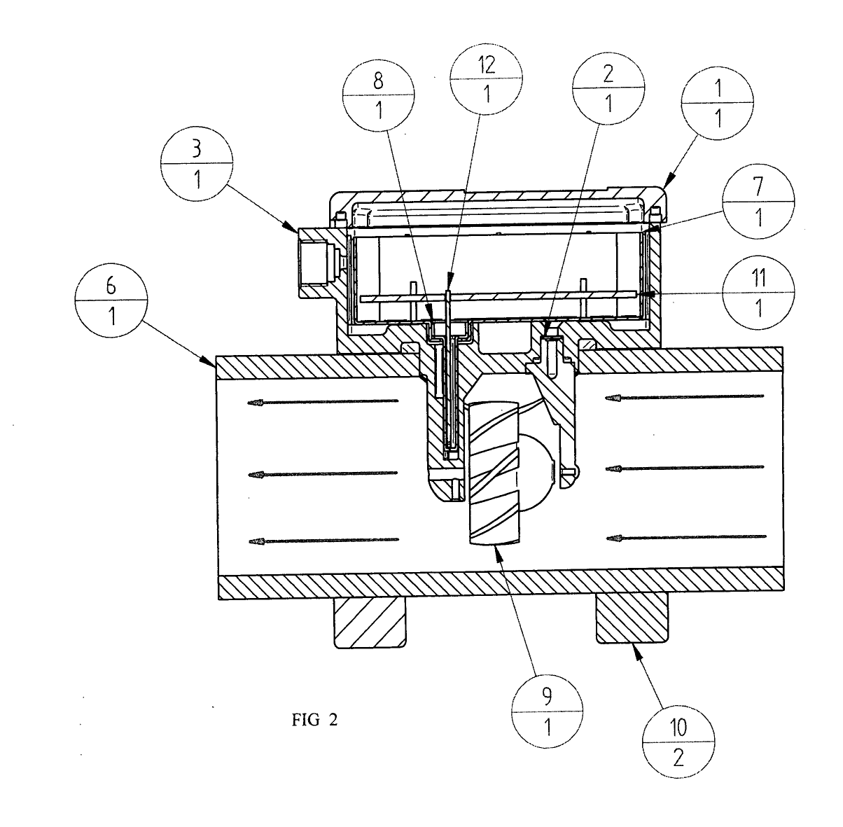

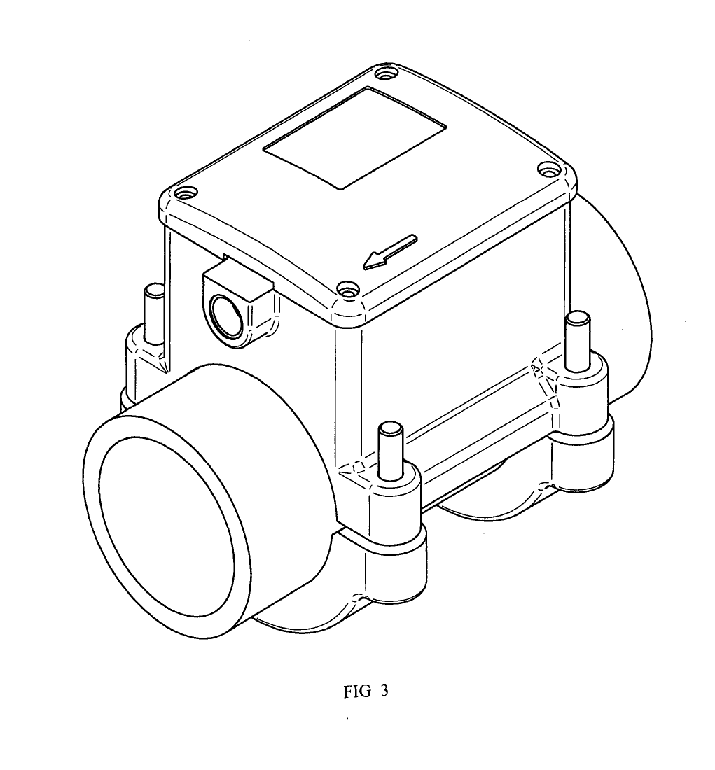

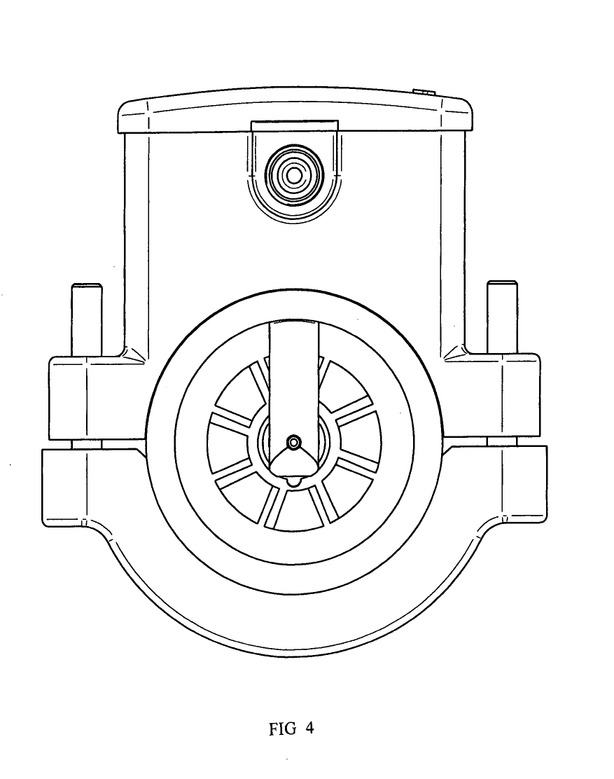

### TECHNICAL FIELD

The present invention refers to a Flow Meter that can be installed on the existing pair of electrical wires that connect an existing electric solenoid water valve and its controller, in addition interface with external sensor (analog signal) and enable on-board flow manipulation.

### BACKGROUND ART

Electric solenoid water valves that are controlled by controllers are customarily installed on water systems, such as irrigation system (hereinafter referred to as “irrigation systems”) and other water supplies. This is done in order to manage the opening and closing of the water valves to enable/disable water flow. A controller and electric solenoid water valve installed on an irrigation system enable the controller to open and close the valves at prescheduled times. A Flow Meter with a solenoid valve that is installed on the system enables to open and close the electric water valves according to the actual consumption or flow rate of water.

A Flow Meter, as implied by its name, measures the quantity of water flowing through the pipe on which it is installed. This information enables to open and close the electric solenoid water valve according to the actual quantity of water consumed and not solely as a function of time also known as flow rate.

Many irrigation systems are equipped with electric water valves and controllers that control the opening and closing of the electric water valves according to prescheduled times. When a user wishes to upgrade such a system and install one or more Flow Meters, it is necessary to connect such Flow Meters to the controller, via a pair of electrical wires, to enable the transfer of information between them. When a Flow Meter is installed on an irrigation system already equipped with an electric water valve and controller, its wiring as described above, which in some cases extends over significant distances, requires a great deal of investment both for labor and material. This new wiring is added to the system in addition to the wires that are already installed and that connect the electric valve to its controller.

The Flow Meter, subject of the present invention, offers a solution to the said problem in that it is designed so that it can be installed at a significant distance from the controller and even from the electric water valve and can be installed on the existing pair of electrical wires that connect the existing water valve to its controller.

### DESCRIPTION OF THE DRAWINGS

The drawings attached to the application do not intend to limit the scope of the invention or its application. The purpose of the drawings is only to illustrate the invention and they present only one its many applications.

Drawing No. 1 depicts the main components of the Flow Meter (100).

Drawing No. 2 presents a side section of the Flow Meter (100).

Drawing No. 3 presents a front section of the Flow Meter (100).

Drawing No. 4 depicts the Flow Meter (100).

### THE INVENTION

The main objective of the present invention is to provide a Flow Meter that is designed so as to be installed at a distance from the controller and even from the electric water valve, on the same pair of electrical wires that connect the existing electric valve to its controller. In other words, the invention aims to provide a Flow Meter that can be installed practically at any point along the relevant pipe without needing to lay out additional electrical wiring. The installer must only cut the pair of wires connecting the existing controller to the existing electric water valve, attach one end of the existing wires to the Flow Meter's inlet and the other end to its outlet, and thus integrate the Flow Meter into the system, without the need to add any electrical wiring.

The Flow Meter, subject of the invention, measures the actual quantity of water flowing through the pipe at relevant times (flow rate) and so it can be used also to detect leaks and conditions in which the electric water valve is open though considered closed by the valve controller (in case of a technical failure in the electric valve or if a foreign body, such as a small stone, prevents the valve from closing despite a “close” command issued by the controller). In such cases, the Flow Meter closes (shutoff) its connected solenoid valve and transmits information to the controller about the flow of water through the pipe and if the according to the controller's setting the electric valve is supposed to be closed, a troubleshooting message is sent to the user to fix the failure.

The Flow Meter (100), subject of the invention, is depicted in Drawings Nos. 1-4 and comprises the following main components: A hollow main body (3) that houses the Flow Meter components; one or more pipe clamps (10) that attach the main body to the existing pipe (7); and an impeller (9) that rotates when water flows through the pipe (7). The impeller (9) is attached to the main body (3) by means of an impeller support (2), a front bearing (5), and a shaft bearing (4), as depicted in the drawings attached to the application. The system also includes an electric circuit (11); the circuit housing (6); a sensor (12); the sensor housing (8); a cover (1); and an electrical cable (13).

Structure and assembly of the Flow Meter components: The main body (3) can be made of a variety of materials, although we recommend that it be made of plastic. The main body (3) is designed to house most of the Flow Meter's internal components and is shaped like an open-top box with a hole in its bottom. The bottom of the main body (3) is rounded to correspond with the shape of the pipe on which it is intended to be attached. The main body (3) is attached to the existing water pipe (7) by means of one or more pipe clamps (10). The drawings depict a Flow Meter equipped with two pipe clamps (10). The impeller (9) protrudes through a hole in the bottom of the main body (3) and is in fact implanted in the existing pipe (7). The impeller (9) acts as a kind of turbine such that when water flows in the pipe (7), the impeller (9) revolves. The circuit housing (6) is an open-top box with a hole in its bottom into which the sensor housing (8), which is a hollow, open-top cylinder, is inserted and attached. The circuit housing and the sensor housing are attached and together constitute a unit that is designed to prevent penetration of water and moisture from the bottom part of the Flow Meter to the electric circuit (11) and sensor (12). The electric circuit (11) is attached to the sensor (12) and they are inserted into the housings (6) and (8). After these components are assembled, the main body (3) is covered with the cover (1).

Operation of the system and electric circuit: The impeller (9) is equipped with a magnet so that every time the sensor (12) [which is protected from contact with the water by being inserted into the sensor housing (8)] senses the passing of the magnet, it sends an electric signal to the electric circuit (11). Thus, the electric circuit receives information about the number of revolutions of the impeller (9). The electric circuit then processes the information based on pre-knowledge about the quantity of water that flows through the pipe per revolution of the impeller (9) as a function of on the relevant pipe's cross-section and based on a calculation of the actual time required for the impeller (9) to complete each revolution, and thus measures the quantity of water flowing through the pipe on which the Flow Meter is installed.

The electric circuit (11) can, among others things, (a) process signals received from the sensor (12) and output a number that expresses the velocity of the water flowing through the pipe (7); (b) send the aforementioned information to the existing controller and/or adaptor (111), unlike conventional Flow Meters that send the information to the controller as electrical pulses, which may create communication or pulses loss problems; (c) can give direct commands to the existing electric valve and/or to other systems, such as valves that introduce fertilizer into the water pipe. In such a case, if the user wishes, for instance, to introduce one unit of fertilizer every 10 units of water, the Flow Meter will send an “open” command to the fertilizer's valve every 10 units of water for a time period that corresponds to the introduction of one unit of fertilizer into the pipe; (d) The electric circuit enables the Flow Meter (100) to communicate with the existing electric valve and controller, unlike existing conventional Flow Meters that function as end units; (e) The electric circuit (11) is designed so that it can be installed on the existing pair of electrical wires (between the existing electric valve and its controller), and can receive and send information and receive electrical power.

Installation of the Flow Meter on the existing pipe and its connection to the existing system: A hole is cut or drilled in the existing pipe (7) and the Flow Meter is placed over the pipe (7) so that the impeller (9) is inserted into the pipe (7). The main body (3) is installed over the pipe (7) and fixed tightly in place using the pipe clamps (10). The existing electrical cable connecting the existing electric valve to its controller is cut and one end of the wire pair is connected to the Flow Meter's inlet and the other end to the Flow Meter's outlet. The physical structure of the Flow Meter (100) enables quick installation on the pipe, unlike the installation of existing Flow Meters that requires cutting the pipes, applying adhesive and waiting several hours for the adhesive to dry before resuming the flow of water through the pipe again. As mentioned, the Flow Meter is equipped with an electrical cable (13) with two or more pairs of wires (inlet, outlet, and optional connection of the gauge to additional systems). Communications between the Flow Meter and the controller enables to send water measuring data from the gauge to the controller and enables the gauge to receive commands and instructions from the controller. The second pair of wires connects the Flow Meter to the existing electric valve and enables it to sends the valve “open” and “close” commands. The said wires are also used to connect the Flow Meter to the source of electrical power.

The Flow Meter (100) can be integrated with a communication adapter (111) that is connected to the existing controller and serves to maintain communications between the Flow Meter (100) and the existing controller.

What is claimed is:

1. A Flow Meter that can be installed onto an existing pair of wires that connect an existing electric valve and its controller without the need to lay out additional electrical wire, which comprises a hollow main body designed to house the Flow Meter's internal components; one or more pipe clamps used to attach the main body to the existing pipe; an impeller that revolves when water flows through the pipe; an electric circuit and housing; a sensor and housing; and a cover.

2. The Flow Meter mentioned in claim No. 1 whereby the impeller is joined to the main body by means of an impeller support, a front bearing and a shaft bearing; whereby the main body is shaped like an open-top box with a hole in its bottom, and the bottom of the main body is rounded to correspond with the shape of the pipe on which it is intended to be attached; whereby the main body is attached to the existing water pipe by means of one or more pipe clamps; whereby the electric circuit's housing is shaped like an open-top box with a hole in its bottom into which the sensor housing, which is a hollow, open-top cylinder, is inserted and attached.

3. The Flow Meter mentioned in claim No. 1 whereby the electric circuit can, among others things, (a) process signals received from the sensor and output a number that expresses the velocity of the water flowing through the pipe; (b) send the aforementioned information to the existing controller and/or adaptor; (c) give direct commands to the existing electric valve and/or to other systems the pipe; (d) enable the Flow Meter to communicate with the existing electric valve and controller; (e) be installed on the existing pair of electrical wires (between the existing electric valve and its controller), and receive and send information and receive electrical power.

4. The Flow Meter mentioned in claim No. 1 whereby it is integrated with a communication adaptor that is connected to the existing controller so as to maintain communication between the Flow Meter and the existing controller.
